(19) United States
(12) Patent Application Publication
(10) Pub. No.: US 2022/0331901 A1
(43) Pub. Date: Oct. 20, 2022

(54) LASER PROCESSING APPARATUS

(71) Applicant: DISCO CORPORATION, Tokyo (JP)

(72) Inventor: Setsuo YAMAMOTO, Tokyo (JP)

(21) Appl. No.: 17/657,434

(22) Filed: Mar. 31, 2022

(30) Foreign Application Priority Data
Apr. 15, 2021 (JP) 2021-069359

(51) Int. Cl. B23K 26/035; B23K 26/10

(52) U.S. Cl. CPC B23K 26/035; B23K 26/10; B23K 2103/54

(57) ABSTRACT

A laser processing apparatus includes a chuck table that holds an SiC ingot on a holding surface, a laser beam irradiation unit that positions the focal point of a laser beam to a depth equivalent to the thickness of a wafer to be produced from a first surface and that irradiates the SiC ingot with the laser beam to form a separation layer arising from separation of SiC into Si and C and extension of cracks along a c-plane. A movement unit relatively moves the chuck table and the laser beam irradiation unit, and a separation layer inspecting unit executes irradiation with inspection light with such a wavelength as to have transmissibility with respect to the SiC ingot and be reflected by the separation layer, and inspects the separation layer from the intensity of reflected light. The holding surface has a color that absorbs the inspection light.

### BACKGROUND OF THE INVENTION

### Field of the Invention

The present invention relates to a laser processing apparatus and particularly to a chuck table of a laser processing apparatus.

### Description of the Related Art

Devices such as integrated circuits (ICs), large-scale integrated (LSI) circuits, light emitting diodes (LEDs), and power devices are formed on functional layers stacked over a surface of a wafer that contains silicon (Si), Al₂O₃ (sapphire), or single-crystal silicon carbide (SiC) as a material, in such a manner as to be marked out by plural planned dividing lines that intersect. The wafer in which the devices are formed is divided into the individual devices through execution of processing on the planned dividing lines by a cutting apparatus or a laser processing apparatus, and the respective devices obtained by the dividing are used for pieces of electrical equipment such as mobile phones and personal computers.

The wafer in which the devices are to be formed is produced by thinly cutting an ingot having a circular column shape in general by a wire saw. A front surface and a back surface of the wafer obtained by the cutting are finished into mirror surfaces by being polished. However, there is a problem that, when the ingot is cut by a wire saw and the front surface and the back surface of the wafer obtained by the cutting are polished, a large part (70% to 80%) of the ingot is discarded, and this is uneconomical. In particular, in the case of an SiC ingot, the hardness thereof is high, and it is difficult to cut the SiC ingot by a wire saw. Thus, a considerable processing time is required, and the productivity is low. In addition, the unit price of the ingot is high, and there is a problem in efficient production of the wafer.

Thus, the present assignee has proposed the following technique: a focal point of a laser beam with a wavelength having transmissibility with respect to single-crystal SiC is positioned inside an SiC ingot, the SiC ingot is irradiated with the laser beam to form a separation layer at a planned cutting plane, and a wafer is separated from the SiC ingot along the planned cutting plane at which the separation layer is formed (for example, refer to Japanese Patent No. 6399913).

However, there is a problem that it becomes difficult to form the proper separation layer along the planned cutting plane with the originally-set processing conditions when the height of the SiC ingot decreases due to repetition of separation of a wafer and change is caused in the crystal structure of the planned cutting plane. Thus, a method has been devised in which a separation layer is irradiated with inspection light in laser processing or after the laser processing and whether the separation layer is properly formed is checked from the brightness of reflected light of the inspection light (for example, refer to Japanese Patent Laid-open No. 2020-205312).

### SUMMARY OF THE INVENTION

However, the production method of a wafer disclosed in Japanese Patent Laid-open No. 2020-205312 involves the following problem. Specifically, when an SiC ingot becomes thin, there is a fear that the brightness of a captured image increases due to the influence of the inspection light reflected by a chuck table (holding surface thereof), the inspection result of the separation layer changes, and an error in the inspection result of the respective separation layers occurs.

Thus, an object of the present invention is to provide a laser processing apparatus that can suppress an error in the inspection result of an SiC ingot.

In accordance with an aspect of the present invention, there is provided a laser processing apparatus that forms a separation layer in an SiC ingot. The laser processing apparatus includes a chuck table that holds the SiC ingot on a holding surface thereof and a laser beam irradiation unit including a beam condenser that positions the focal point of a laser beam with a wavelength having transmissibility with respect to SiC, to a depth equivalent to the thickness of a wafer to be produced from an upper surface of the SiC ingot, and that irradiates the SiC ingot with the laser beam to form the separation layer arising from separation of SiC into Si and carbon (C) and extension of cracks along a c-plane. The laser processing apparatus also includes a movement unit that relatively moves the chuck table and the laser beam irradiation unit and a separation layer inspecting unit that executes irradiation with inspection light with such a wavelength as to have transmissibility with respect to the SiC ingot and be reflected by the separation layer and that inspects the separation layer from the intensity of reflected light. The holding surface of the chuck table has a color that absorbs the inspection light.

Preferably, the inspection light is visible light. Preferably, the holding surface of the chuck table includes a porous plate. Preferably, the porous plate is composed of porous glass.

According to the present invention, an effect that an error in the inspection result of the SiC ingot can be suppressed is provided.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view illustrating a configuration example of a laser processing apparatus according to a first embodiment;

FIG. 2 is a plan view of an SiC ingot that is a processing target of the laser processing apparatus illustrated in FIG. 1;

FIG. 3 is a side view of the SiC ingot illustrated in FIG. 2;

FIG. 4 is a perspective view of a wafer manufactured through separation of one part of the SiC ingot illustrated in FIG. 2;

FIG. 5 is a partially sectional side view illustrating a chuck table of the laser processing apparatus illustrated in FIG. 1;

FIG. 6 is a perspective view illustrating the state in which the laser processing apparatus illustrated in FIG. 1 forms separation layers in the SiC ingot;

FIG. 7 is a sectional view illustrating part of the state in which the laser processing apparatus illustrated in FIG. 1 forms the separation layers in the SiC ingot;

FIG. 8 is a perspective view illustrating the state in which the laser processing apparatus illustrated in FIG. 1 forms separation layers for inspection in the SiC ingot held on the chuck table;

FIG. 9 is a sectional view illustrating part of the state in which the laser processing apparatus illustrated in FIG. 1 forms the separation layers for inspection in the SiC ingot held on the chuck table;

FIG. 10 is a side view schematically illustrating the state in which a separation layer inspecting unit of the laser processing apparatus illustrated in FIG. 1 images the separation layers for inspection that are formed in the SiC ingot;

FIGS. 11A to 11D are diagrams schematically illustrating images captured by the separation layer inspecting unit illustrated in FIG. 10; and

FIG. 12 is a side view schematically illustrating the state in which a detecting unit of a laser processing apparatus according to a second embodiment detects a Facet region in the SiC ingot.

### DETAILED DESCRIPTION OF THE PREFERRED EMBODIMENTS

Embodiments of the present invention will be described in detail below with reference to the drawings. The present invention is not limited by contents described in the following embodiments. Further, what can easily be envisaged by those skilled in the art and what are substantially the same are included in constituent elements described below. Moreover, configurations described below can be combined as appropriate. In addition, various kinds of omission, replacement, or change of a configuration can be carried out without departing from the gist of the present invention.

### First Embodiment

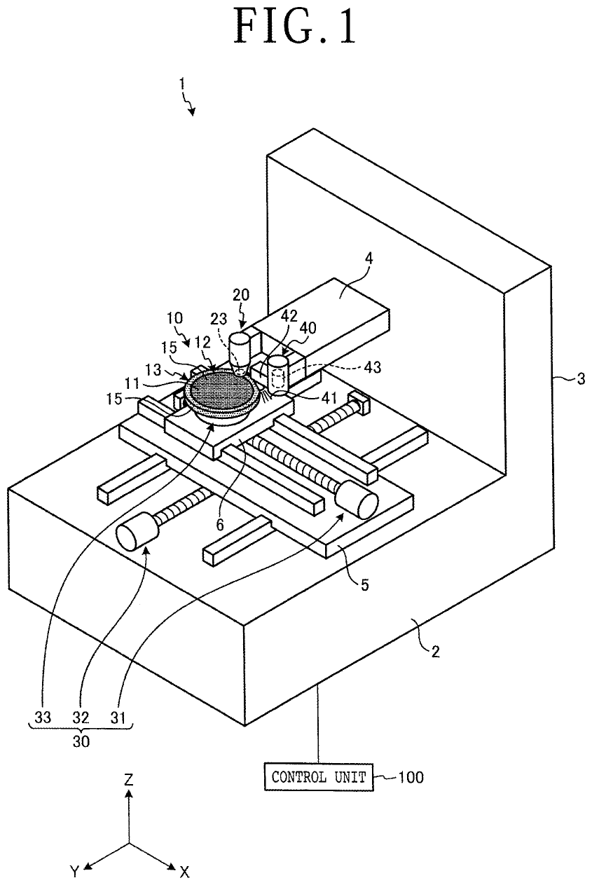

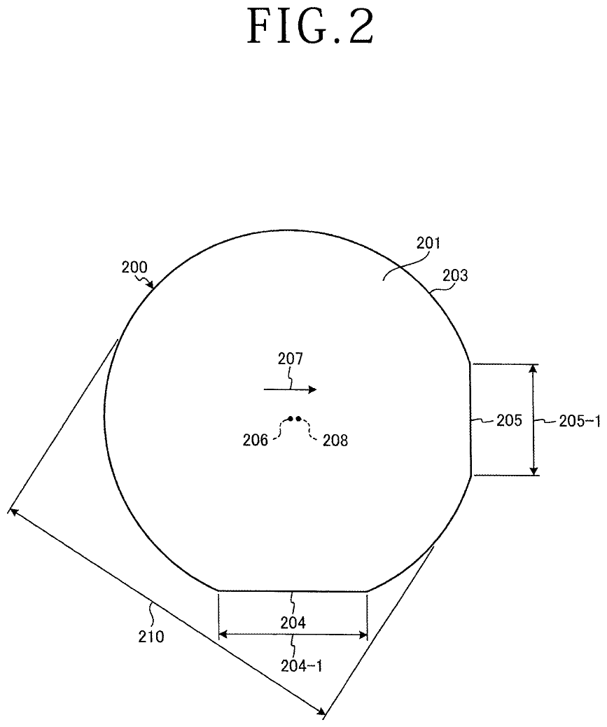

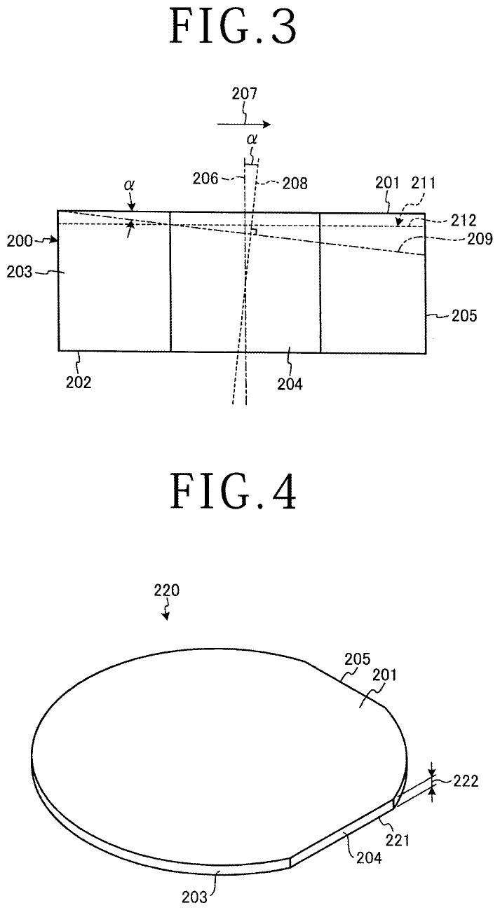

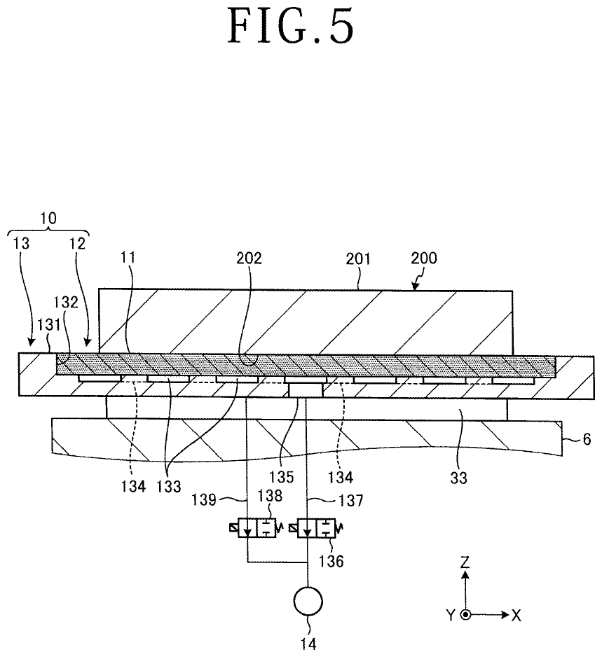

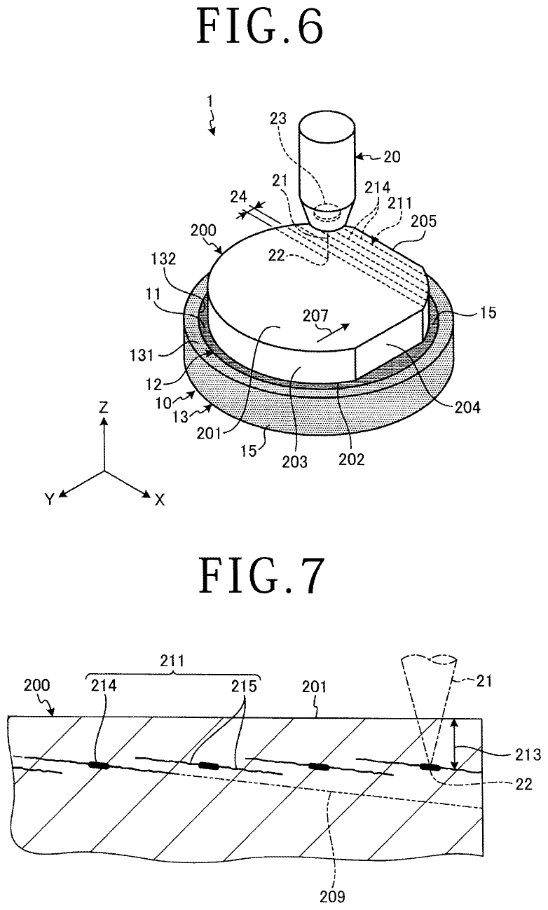

A laser processing apparatus 1 according to a first embodiment of the present invention will be described based on drawings. FIG. 1 is a perspective view illustrating a configuration example of the laser processing apparatus according to the first embodiment. FIG. 2 is a plan view of an SiC ingot that is a processing target of the laser processing apparatus illustrated in FIG. 1. FIG. 3 is a side view of the SiC ingot illustrated in FIG. 2. FIG. 4 is a perspective view of a wafer manufactured through separation of one part of the SiC ingot illustrated in FIG. 2. FIG. 5 is a partially sectional side view illustrating a chuck table of the laser processing apparatus illustrated in FIG. 1. FIG. 6 is a perspective view illustrating the state in which the laser processing apparatus illustrated in FIG. 1 forms separation layers in the SiC ingot. FIG. 7 is a sectional view illustrating part of the state in which the laser processing apparatus illustrated in FIG. 1 forms the separation layers in the SiC ingot.

(SiC Ingot)

The laser processing apparatus 1 illustrated in FIG. 1 according to the first embodiment is a processing apparatus that executes laser processing on an SiC ingot 200 illustrated in FIG. 2. The SiC ingot 200 that is a processing target of the laser processing apparatus 1 according to the first embodiment and that is illustrated in FIG. 2 and FIG. 3 is composed of SiC and is formed into a circular column shape as a whole in the first embodiment. In the first embodiment, the SiC ingot 200 is a hexagonal single-crystal SiC ingot.

As illustrated in FIG. 2 and FIG. 3, the SiC ingot 200 has a first surface 201 that is formed into a circular shape and that is an upper surface, a second surface 202 that is on the back side of the SiC ingot 200 with respect to the first surface 201 and that is formed into a circular shape, and a circumferential surface 203 continuous with an outer edge of the first surface 201 and an outer edge of the second surface 202. Further, the SiC ingot 200 has, in the circumferential surface 203, a first orientation flat 204 that indicates the crystal orientation and a second orientation flat 205 orthogonal to the first orientation flat 204. A length 204-1 of the first orientation flat 204 is longer than a length 205-1 of the second orientation flat 205.

Moreover, the SiC ingot 200 has a c-axis 208 and a c-plane 209. The c-axis 208 is inclined in an inclination direction 207 toward the second orientation flat 205 by an off-angle α with respect to a perpendicular line 206 that is perpendicular to the first surface 201. The c-plane 209 is orthogonal to the c-axis 208. The c-plane 209 is inclined with respect to the first surface 201 of the SiC ingot 200 by the off-angle α. The inclination direction 207 of the c-axis 208 from the perpendicular line 206 is orthogonal to the extension direction of the second orientation flat 205 and is parallel to the first orientation flat 204.

An infinite number of c-planes 209 are set in the SiC ingot 200 at the molecular level of the SiC ingot 200. In the first embodiment, the off-angle α is set to 1°, 4°, or 6°. However, in the present invention, the SiC ingot 200 can be manufactured with the off-angle α freely set in a range of 1° to 6°, for example.

Further, for the SiC ingot 200, the first surface 201 is subjected to grinding processing by a grinding apparatus and is then subjected to polishing processing by a polishing apparatus. Thus, the first surface 201 is formed into a mirror surface. One part of the SiC ingot 200 on the side of the first surface 201 is separated from the SiC ingot 200, and a wafer 220 illustrated in FIG. 4 is obtained from the separated one part. Moreover, as the SiC ingot 200, plural kinds of ingots different in a diameter 210 exist.

The wafer 220 illustrated in FIG. 4 is manufactured through separation of one part of the SiC ingot 200 including the first surface 201 thereof as the wafer 220 and through execution of grinding processing, polishing processing, and so forth on a separation surface 221 separated from the SiC ingot 200. After the wafer 220 is separated from the SiC ingot 200, devices are formed on a front surface of the wafer 220. In the first embodiment, the device is a metal-oxide-semiconductor field-effect transistor (MOSFET), micro electro mechanical systems (MEMS), or a Schottky barrier diode (SBD). However, in the present invention, the device is not limited to the MOSFET, the MEMS, and the SBD. Note that parts of the wafer 220 that are the same as the SiC ingot 200 are given the same reference signs, and description thereof is omitted.

In the SiC ingot 200 illustrated in FIG. 2 and FIG. 3, after a separation layer 211 illustrated in FIG. 3 is formed, one part, i.e., the wafer 220 to be produced, is split and separated with the separation layer 211 being the point of origin. The separation layer 211 is formed by the laser processing apparatus 1 according to the first embodiment. Further, a separation surface 212 of the SiC ingot 200 from which the wafer 220 is separated is formed into a mirror surface by grinding processing and polishing processing, and the separation surface 212 is formed into the first surface 201. Then, the separation layer 211 is formed, and the wafer 220 is separated again. In this manner, the thickness of the SiC ingot 200 becomes thinner in association with the separation of the wafer 220, and the separation layer 211 is formed and the wafer 220 is separated until the thickness of the SiC ingot 200 becomes a predetermined thickness.

(Laser Processing Apparatus)

The laser processing apparatus 1 according to the first embodiment is a processing apparatus that forms the separation layer 211 in the SiC ingot 200. As illustrated in FIG. 1, the laser processing apparatus 1 has a chuck table 10 that holds the SiC ingot 200, a laser beam irradiation unit 20, a movement unit 30, a separation layer inspecting unit 40 that irradiates the SiC ingot 200 held by the chuck table 10 with inspection light 41 (that is illustrated in FIG. 1 and is visible light in the first embodiment) to inspect the separation layer 211, and a control unit 100.

The chuck table 10 is disposed on a rotational movement unit 33 of the movement unit 30 and holds the SiC ingot 200 on a holding surface 11 thereof that is parallel to the horizontal direction. As illustrated in FIG. 1 and FIG. 5, the chuck table 10 includes a circular plate-shaped porous plate 12 that forms the holding surface 11 on which the SiC ingot 200 is held under suction, and a base 13 that surrounds the outer circumference of the porous plate 12.

In the first embodiment, the base 13 is composed of a metal such as stainless steel. The base 13 is a non-porous body having air impermeability and is formed into a thick circular plate shape. The base 13 is disposed on the rotational movement unit 33 of the movement unit 30. As illustrated in FIG. 5, the outer diameter of the base 13 is set to a larger diameter than that of the SiC ingot 200, and a recess part 132 into which the porous plate 12 is attached is made at the center of an upper surface 131 of the base 13. In the base 13, the upper surface 131 is located on the same plane as the holding surface 11 when the porous plate 12 is attached into the recess part 132.

The recess part 132 has a planar shape formed into a circular shape and has an outer diameter set larger than that of the SiC ingot 200. The recess part 132 is disposed at such a position as to be coaxial with the base 13. In the recess part 132, plural suction grooves 133 with a shape of concentric circles and suction grooves 134 for connection that cause the suction grooves 133 to communicate with each other are made in a bottom surface 34. These suction grooves 133 and 134 are formed so as to be recessed from the bottom surface of the recess part 132. Further, a communication path 135 opened in the bottom surface of the recess part 132 communicates with these suction grooves 133 and 134.

The communication path 135 is connected to a suction path 137 that is connected to a suction source 14 such as an ejector and on which an opening-closing valve 136 is disposed. When the opening-closing valve 136 is opened and a negative pressure from the suction source 14 acts on the suction path 137, the base 13 causes the negative pressure from the suction source 14 to act on the porous plate 12 fitted into the recess part 132 and sucks the holding surface 11 of the porous plate 12. Moreover, when the base 13 is disposed on the rotational movement unit 33, a branch suction path 139 that branches from the suction path 137 and on which an opening-closing valve 138 is disposed faces the bottom surface of the base 13. When the opening-closing valve 138 is opened and the negative pressure from the suction source 14 acts on the branch suction path 139, the bottom surface of the base 13 is sucked by the rotational movement unit 33, and the base 13 is fixed.

Further, in the first embodiment, an outer front surface of the base 13 (particularly an outer front surface on the outer circumferential side relative to the recess part 132) has a color 15 (illustrated by coarse hatching in FIG. 1) that absorbs the inspection light 41. The color 15 that absorbs the inspection light 41 is a color with higher absorptance of the inspection light 41 than white, brown, and silver, which are the colors of the outer front surface of the chuck table used conventionally. It is desirable that the color 15 that absorbs the inspection light 41 be what is called a dark color. The dark color is dark grey as an achromatic color or a dark chromatic color that includes black and that has a low color value. Further, it is desirable that the color 15 be a deep dark color, and it is desirable that the color 15 be black.

As above, the color 15 that absorbs the inspection light 41 includes a dark color, a deep dark color, and black. In the first embodiment, the color of the outer front surface of the base 13 (particularly the outer front surface on the outer circumferential side relative to the recess part 132) is black as the color 15 that absorbs the inspection light 41. In the first embodiment, paint of black as the color 15 that absorbs the inspection light 41 is applied to the outer front surface of the base 13 (particularly the outer front surface on the outer circumferential side relative to the recess part 132). As above, in the present invention, it is desirable that the color of the outer front surface of the base 13 be a dark color, a deep dark color, or black.

The porous plate 12 is a circular plate-shaped porous body that has air permeability, and has an outer diameter that is larger than the outer diameter of the SiC ingot 200 and that is equal to the inner diameter of the recess part 132. The porous plate 12 is fixed into the recess part 132, and a lower surface thereof is fixed to the bottom surface of the recess part 132 of the base 13 by an adhesive that is not illustrated in the diagram. An upper surface of the porous plate 12 is the holding surface 11 that holds the SiC ingot 200 under suction. Accordingly, the holding surface 11 of the chuck table 10 includes the porous plate 12.

The porous plate 12 is fixed to the base 13, and the holding surface 11 is ground to be flatly formed in parallel to the horizontal direction. The holding surface 11 of the porous plate 12 is located on the same plane as the upper surface 131 of the base 13. The porous plate 12 is connected to the suction source 14 through the communication path 135 made in the base 13 and the suction path 137. When the opening-closing valve 136 is opened and the negative pressure from the suction source 14 acts on the porous plate 12, the porous plate 12 holds the SiC ingot 200 under suction on the holding surface 11.

In the first embodiment, the porous plate 12 is formed by coupling plural glass particles with each other. The glass particle is composed of soda glass (in the first embodiment, soda-lime glass) which is a glass material having transparency to visible light. Each glass particle has a spherical shape and has a substantially equivalent particle size. It is preferable that the glass particles are dense particles that do not have an air bubble. Such glass particles can be manufactured by spray drying, for example.

A spray drier (splay driving apparatus) has a nozzle or disc for atomizing a raw liquid of glass. The raw liquid of glass atomized into the spherical shape by the surface tension and so forth is exposed to hot air supplied into a drying chamber. Thus, the atomized raw liquid solidifies to become glass particles having the spherical shape and an equivalent particle size.

In the first embodiment, glass particles having a particle size of at least 3 μm and at most 4 mm are used. The particle size of the glass particles is more preferably at least 5 μm and at most 300 μm and is further preferably at least 30 μm and at most 200 μm.

The particle size of the glass particles has predetermined variation according to a Gaussian distribution. For example, when the particle size of the glass particles is a predetermined value of at most 100 μm, a particle group in which the standard deviation is equal to or smaller than 5 μm is used. Further, for example, when the particle size of the glass particles is a predetermined value of at least 101 μm and at most 300 μm, a particle group in which the standard deviation is equal to or smaller than 10 μm is used.

The porous plate 12 is manufactured as follows. First, plural glass particles are put in a mold (not illustrated) having a recess part with a circular disc shape and are sealed by a lid plate (not illustrated). Then, the mold, the lid plate, and the glass particles are put in a baking furnace and are baked at a predetermined temperature of at least 600° C. and at most 1300° C.

In the first embodiment, the glass particles are baked at a predetermined temperature of at least 700° C. and at most 800° C. for a predetermined period of time of at least approximately 30 minutes and at most approximately 3 hours. By the baking, the porous plate 12 in which adjacent ones of the spherical glass particles are partly connected to each other with pores left in a gap between the adjacent glass particles is manufactured. In this manner, the porous plate 12 is composed of porous glass.

As the time for which the glass particles are baked is longer, the time for which the glass material is fluid becomes longer. Thus, the contact area between the glass particles increases, and the porosity becomes lower. For example, the porosity of the porous plate 12 of which the baking time is 3 hours is lower than that of the porous plate 12 of which the baking time is 30 minutes.

In the first embodiment, the porosity of the porous plate 12 is at least 5% and at most 40% in volume ratio. The porosity can be adjusted as appropriate based on the temperature in baking, the pressure, the amount of frit added to the glass particles, and so forth in addition to the baking time. The frit is powders that are formed of the same glass material as the glass particles and that have a smaller diameter than that of the glass particles.

In the case in which the pressure of suction applied from the suction source 14 is −92.7 kPa (gauge pressure) in the state in which the porous plate 12 is attached to the recess part 132 and the base 13 is fixed to the rotational movement unit 33, the pressure in the suction path 137 becomes at least −65 kPa (gauge pressure) and at most −50 kPa (gauge pressure) when nothing is placed on the holding surface 11. Further, in the case in which the pressure of suction applied from the suction source 14 is −92.7 kPa (gauge pressure) in the state in which the porous plate 12 is attached to the recess part 132 and the base 13 is fixed to the rotational movement unit 33, the pressure in the suction path 137 becomes −84.2 kPa (gauge pressure) when the SiC ingot 200 whose diameter 210 is 4 inches is placed on the holding surface 11, the pressure in the suction path 137 becomes −87.9 kPa (gauge pressure) when the SiC ingot 200 whose diameter 210 is 6 inches is placed on the holding surface 11, and the pressure in the suction path 137 becomes −91.5 kPa (gauge pressure) when the SiC ingot 200 whose diameter 210 is 8 inches is placed on the holding surface 11.

Further, in the first embodiment, in the porous plate 12, at least the holding surface 11 has the color 15 (illustrated by dense hatching in FIG. 1) that absorbs the inspection light 41, similarly to the base 13. In the first embodiment, the porous plate 12 is formed by mixing black pigments such as carbon powders or powders of a mineral into glass particles and so forth, and the whole color of the porous plate 12 is black as the color 15 that absorbs the inspection light 41. Further, in the present invention, paint of black as the color 15 that absorbs the inspection light 41 may be applied to at least the holding surface 11 of the porous plate 12 similarly to the base 13.

Note that, in the first embodiment, the color 15 that absorbs the inspection light 41 is black. However, in the present invention, the color 15 is not limited to black as long as it is a color with higher absorptance of the inspection light 41 than white, brown, and silver, which are the colors of the outer front surface of the chuck table used conventionally. As above, in the present invention, it is desirable that the holding surface 11 of the chuck table 10 have a dark color, a deep dark color, or black. Note that, in the present invention, the color 15 of the base 13 and the color 15 of the porous plate 12 may be the same color or may be different colors.

In the first embodiment, the porous plate 12 is a porous body formed by coupling plural glass particles with each other. However, in the present invention, the porous plate 12 may be a porous body such as porous ceramic. The porous body includes aggregates that are abrasive grains of alumina or the like and a bond that fixes the aggregates to each other, and has pores formed in gaps between the aggregates and the bond, for example.

The chuck table 10 with the above-described configuration is fixed to the rotational movement unit 33 by being sucked by the suction source 14 and holds, under suction, the SiC ingot 200 placed on the holding surface 11. In the first embodiment, the chuck table 10 holds the second surface 202 of the SiC ingot 200 under suction on the holding surface 11.

Further, the chuck table 10 is rotated by the rotational movement unit 33 of the movement unit 30 around the axial center parallel to a Z-axis direction that is orthogonal to the holding surface 11 and that is parallel to the vertical direction. Together with the rotational movement unit 33, the chuck table 10 is moved in an X-axis direction parallel to the horizontal direction by an X-axis movement unit 31 of the movement unit 30 and is moved in a Y-axis direction that is parallel to the horizontal direction and that is orthogonal to the X-axis direction, by a Y-axis movement unit 32. The chuck table 10 is moved by the movement unit 30 between a processing region under the laser beam irradiation unit 20 and a carrying-in/out region to and from which the SiC ingot 200 is carried in and carried out. The carrying-in/out region is spaced from the lower side of the laser beam irradiation unit 20.

The laser beam irradiation unit 20 includes a beam condenser 23 that positions a focal point 22 (illustrated in FIG. 7) of a pulsed laser beam 21 (illustrated in FIG. 6 and FIG. 7) with a wavelength having transmissibility with respect to the SiC ingot 200 held by the chuck table 10, to a depth 213 equivalent to a thickness 222 (illustrated in FIG. 4) of the wafer 220 to be produced from the first surface 201 of the SiC ingot 200, and that irradiates the SiC ingot 200 with the laser beam 21 to form the separation layer 211 arising from separation of SiC into Si and C and extension of cracks 215 along the c-plane 209.

When the SiC ingot 200 is irradiated with the pulsed laser beam 21 with the wavelength having transmissibility with respect to the SiC ingot 200 while being moved relative to the laser beam 21 along the second orientation flat 205, as illustrated in FIG. 6 and FIG. 7, modified parts 214 are formed inside the SiC ingot 200 along the second orientation flat 205. In the modified parts 214, SiC is separated into Si and C due to the irradiation with the pulsed laser beam 21, and the pulsed laser beam 21 with which irradiation is executed next is absorbed by previously-formed C, separating SiC into Si and C in a chain-reaction manner. In addition, the cracks 215 that extend from the modified parts 214 along the c-plane 209 are produced. In this manner, when the irradiation with the pulsed laser beam 21 with the wavelength having transmissibility with respect to the SiC ingot 200 is executed, the laser beam irradiation unit 20 forms, in the SiC ingot 200, the separation layers 211 including the modified part 214 and the cracks 215 formed from the modified part 214 along the c-plane 209.

In the first embodiment, as illustrated in FIG. 1, the laser beam irradiation unit 20 is supported by the tip of a support column 4 supported by an erected wall 3 disposed upright from an apparatus main body 2. The laser beam irradiation unit 20 includes a laser oscillator that oscillates a pulsed laser for processing the SiC ingot 200 and that emits the laser beam 21, and the beam condenser 23 that focuses the laser beam 21 emitted from the laser oscillator on the SiC ingot 200 held on the holding surface 11 of the chuck table 10 and that forms the separation layer 211.

The beam condenser 23 includes a condensing lens that is disposed at such a position as to face the holding surface 11 of the chuck table 10 in the Z-axis direction and that is not illustrated in the diagram. The condensing lens allows the laser beam 21 emitted from the laser oscillator, to be transmitted through the condensing lens, and focuses the laser beam 21 on the focal point 22. Further, in the first embodiment, the beam condenser 23 is disposed so as to be movable in the Z-axis direction by a focal point movement unit that is not illustrated in the diagram.

The movement unit 30 relatively moves the chuck table 10 and the laser beam irradiation unit 20 in the X-axis direction and the Y-axis direction and around the axial center parallel to the Z-axis direction. The X-axis direction and the Y-axis direction are directions parallel to the holding surface 11, i.e., the horizontal direction. The X-axis direction is what is called a processing feed direction in which the laser processing apparatus 1 executes processing feed of the chuck table 10 when executing laser processing on the SiC ingot 200. The Y-axis direction is orthogonal to the X-axis direction and is what is called an indexing feed direction in which the laser processing apparatus 1 executes indexing feed of the chuck table 10 when executing laser processing on the SiC ingot 200.

The movement unit 30 includes the X-axis movement unit 31, the Y-axis movement unit 32, and the rotational movement unit 33. The X-axis movement unit 31 is an X-axis movement unit that moves the chuck table 10 in the X-axis direction. The Y-axis movement unit 32 is a Y-axis movement unit that moves the chuck table 10 in the Y-axis direction. The rotational movement unit 33 rotates the chuck table 10 around the axial center parallel to the Z-axis direction.

The Y-axis movement unit 32 is a unit that executes indexing feed of the chuck table 10 and the laser beam irradiation unit 20 relatively. In the first embodiment, the Y-axis movement unit 32 is disposed on the apparatus main body 2 of the laser processing apparatus 1. The Y-axis movement unit 32 supports, movably in the Y-axis direction, a moving plate 5 that supports the X-axis movement unit 31.

The X-axis movement unit 31 is a unit that executes processing feed of the chuck table 10 and the laser beam irradiation unit 20 relatively. The X-axis movement unit 31 is disposed on the moving plate 5. The X-axis movement unit 31 supports, movably in the X-axis direction, a second moving plate 6 supporting the rotational movement unit 33 that rotates the chuck table 10 around the axial center parallel to the Z-axis direction.

The X-axis movement unit 31 and the Y-axis movement unit 32 each include a well-known ball screw disposed rotatably around the axial center, a well-known pulse motor that rotates the ball screw around the axial center, and well-known guide rails that support the moving plate 6 or 5 movably in the X-axis direction or the Y-axis direction.

Further, the laser processing apparatus 1 includes an X-axis direction position detecting unit that detects the position of the chuck table 10 in the X-axis direction and that is not illustrated in the diagram, a Y-axis direction position detecting unit that detects the position of the chuck table 10 in the Y-axis direction and that is not illustrated in the diagram, and a Z-axis direction position detecting unit that detects the position in the Z-axis direction regarding the condensing lens included in the laser beam irradiation unit 20. Each position detecting unit outputs a detection result to the control unit 100.

The separation layer inspecting unit 40 irradiates the SiC ingot 200 held by the chuck table 10, with the inspection light 41 with such a wavelength as to have transmissibility with respect to the SiC ingot 200 and be reflected by the separation layer 211, and inspects the separation layer 211 from the intensity of reflected light. The separation layer inspecting unit 40 includes a light emitter 42 that irradiates the separation layer 211 formed in the SiC ingot 200 held by the chuck table 10 with the inspection light 41 and a camera 43 that images the separation layer 211.

The inspection light 41 with which irradiation is executed by the light emitter 42 is transmitted through the first surface 201 of the SiC ingot 200 and is reflected by the cracks 215 of the separation layer 211. Further, the inspection light 41 is also reflected from the holding surface 11 of the chuck table 10. Regarding the inspection light 41, the intensity of light reflected from the holding surface 11 of the chuck table 10 becomes stronger as the thickness of the SiC ingot 200 becomes thinner.

The camera 43 includes an imaging element such as a charge coupled device (CCD) imaging element or a complementary MOS (CMOS) imaging element that images the inspection light 41 reflected from the separation layer 211 and the holding surface 11. In the first embodiment, the separation layer inspecting unit 40 is attached to the tip of the support column 4 and is disposed at such a position as to be lined up with the condensing lens of the beam condenser 23 of the laser beam irradiation unit 20 in the X-axis direction. The separation layer inspecting unit 40 images the SiC ingot 200 and acquires an image to output the acquired image to the control unit 100.

Note that, in the first embodiment, the image captured by the separation layer inspecting unit 40 is a grayscale image or a color image in which the intensity of the inspection light 41 is defined with grayscales of plural stages (for example, 256 grayscales). Further, in the first embodiment, the inspection light 41 with which the SiC ingot 200 is irradiated by the light emitter 42 and the inspection light 41 imaged by the camera 43 are both visible light.

The control unit 100 controls each of the above-described constituent elements of the laser processing apparatus 1 and causes the laser processing apparatus 1 to execute processing operation for the SiC ingot 200. Note that the control unit 100 is a computer that includes a calculation processing device having a microprocessor such as a central processing unit (CPU), a storing device having a memory such as a read only memory (ROM) or a random access memory (RAM), and an input-output interface device. The calculation processing device of the control unit 100 executes calculation processing according to a computer program stored in the storing device and outputs a control signal for controlling the laser processing apparatus 1, to the above-described constituent elements of the laser processing apparatus 1 through the input-output interface device, to implement functions of the control unit 100.

Further, the control unit 100 is connected to a display unit 110 and an input unit which is not illustrated in the diagram. The display unit 110 includes a liquid crystal display device or the like that displays the state of processing operation, images, and so forth. The input unit is used when an operator registers information regarding the details of processing or the like. The input unit includes at least one of a touch panel disposed in the display unit 110 and an external input device such as a keyboard.

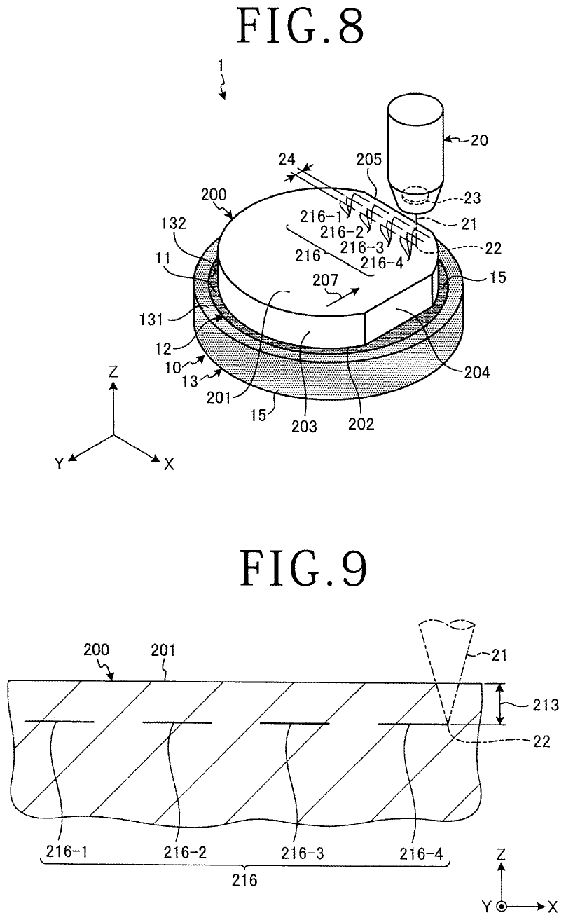

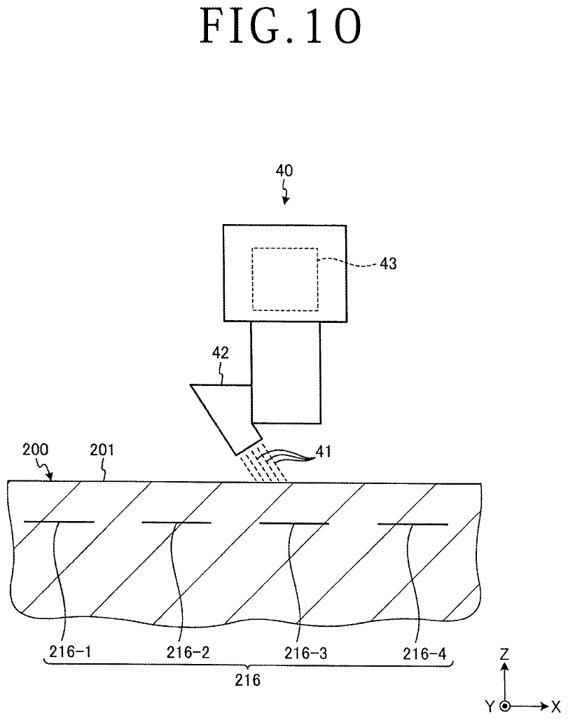

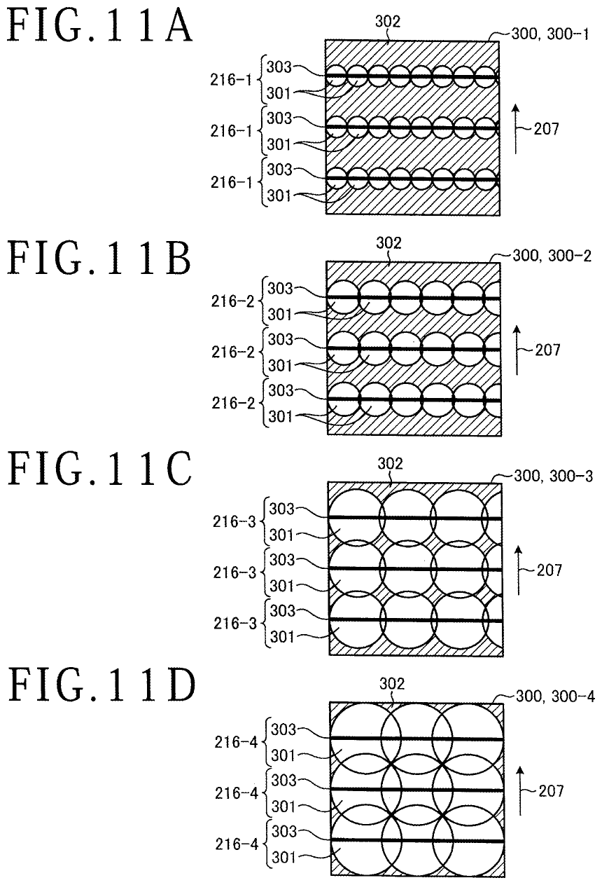

Next, processing operation of the laser processing apparatus 1 according to the first embodiment will be described. FIG. 8 is a perspective view illustrating the state in which the laser processing apparatus illustrated in FIG. 1 forms separation layers for inspection in the SiC ingot held on the chuck table. FIG. 9 is a sectional view illustrating part of the state in which the laser processing apparatus illustrated in FIG. 1 forms the separation layers for inspection in the SiC ingot held on the chuck table. FIG. 10 is a side view schematically illustrating the state in which the separation layer inspecting unit of the laser processing apparatus illustrated in FIG. 1 images the separation layers for inspection that are formed in the SiC ingot. FIGS. 11A to 11D are diagrams schematically illustrating images captured by the separation layer inspecting unit illustrated in FIG. 10.

In the laser processing apparatus 1, an operator registers processing conditions in the control unit 100. Then, the chuck table 10 is placed on the rotational movement unit 33, and the second surface 202 of the SiC ingot 200 is placed on the holding surface 11 of the chuck table 10. When accepting an instruction to start processing operation from the operator, the control unit 100 of the laser processing apparatus 1 opens the opening-closing valve 138 to fix the chuck table 10 to the rotational movement unit 33 and starts the processing operation.

In the processing operation, the control unit 100 of the laser processing apparatus 1 opens the opening-closing valve 136 to hold the second surface 202 of the SiC ingot 200 under suction on the holding surface 11 of the chuck table 10 as illustrated in FIG. 5. In the processing operation, the control unit 100 of the laser processing apparatus 1 controls the movement unit 30 to move the chuck table 10 to the lower side of the camera 43 of the separation layer inspecting unit 40 and causes the camera 43 to image the SiC ingot 200.

The control unit 100 of the laser processing apparatus 1 positions an outer circumferential region of the SiC ingot 200 (outer circumferential surplus region in which devices are not to be formed in the wafer 220 produced from the SiC ingot 200) directly under the beam condenser 23 of the laser beam irradiation unit 20, by adjusting the position of the chuck table 10 by the X-axis movement unit 31 and the Y-axis movement unit 32 on the basis of an image of the SiC ingot 200 captured by the camera 43. Further, by adjusting the orientation of the chuck table 10 around the axial center by the rotational movement unit 33, the control unit 100 of the laser processing apparatus 1 sets the second orientation flat 205 so as to be parallel to the X-axis direction, sets a direction orthogonal to the inclination direction 207 so as to be parallel to the X-axis direction, and sets the inclination direction 207 so as to be parallel to the Y-axis direction.

Subsequently, the control unit 100 of the laser processing apparatus 1 adjusts the position of the beam condenser 23 in the Z-axis direction by the focal point movement unit, to position the focal point 22 of the laser beam 21 to the depth 213 equivalent to the thickness 222 of the wafer 220 to be produced from the first surface 201 of the SiC ingot 200. The control unit 100 of the laser processing apparatus 1 causes the beam condenser 23 to irradiate the SiC ingot 200 with the laser beam 21 with a wavelength having transmissibility with respect to SiC while causing the X-axis movement unit 31 to execute processing feed of the chuck table 10 at a predetermined processing feed rate along the X-axis direction, i.e., along the second orientation flat 205, to thereby form a separation layer 216 for inspection. Note that the separation layer 216 for inspection is formed in the outer circumferential region (outer circumferential surplus region in which devices are not to be formed) that is located on the inner circumferential side with respect to the outer edge of the SiC ingot 200 and that has a width of approximately 2 mm from this outer edge. Therefore, the separation layer 216 for inspection does not lower the quality of the device when the devices are formed in the wafer 220 produced from the SiC ingot 200.

Further, in the formation of the separation layer 216 for inspection, the control unit 100 of the laser processing apparatus 1 irradiates the SiC ingot 200 with the pulsed laser beam 21 while changing the output power of the laser beam 21 with which irradiation is executed by the laser beam irradiation unit 20, to form plural separation layers 216 for inspection that are different in the output power of the laser beam 21. Similarly to the separation layer 211, the separation layer 216 for inspection includes a modified part and cracks that extend from the modified part along the c-plane 209. In the modified part, SiC is separated into Si and C due to the irradiation with the pulsed laser beam 21, and the pulsed laser beam 21 with which irradiation is executed next is absorbed by previously-formed C, separating SiC into Si and C in a chain-reaction manner.

In the first embodiment, as illustrated in FIG. 8, the laser processing apparatus 1 forms the following separation layers 216: the separation layer 216 (hereinafter, denoted by a reference sign 216-1) formed through irradiation with the laser beam 21 with first output power (in the first embodiment, 4 W); the separation layer 216 (hereinafter, denoted by a reference sign 216-2) formed through irradiation with the laser beam 21 with second output power (in the first embodiment, 5 W) different from the first output power; the separation layer 216 (hereinafter, denoted by a reference sign 216-3) formed through irradiation with the laser beam 21 with third output power (in the first embodiment, 6 W) different from both the first output power and the second output power; and the separation layer 216 (hereinafter, denoted by a reference sign 216-4) formed through irradiation with the laser beam 21 with fourth output power (in the first embodiment, 7 W) different from all the first output power, the second output power, and the third output power. Note that values of the output power and the number of separation layers 216-1, 216-2, 216-3, and 216-4 can each be set as desired.

The control unit 100 of the laser processing apparatus 1 causes the Y-axis movement unit 32 to move the chuck table 10, to thereby move the SiC ingot 200 relative to the laser beam irradiation unit 20 along the Y-axis direction, i.e., along the first orientation flat 204, by a predetermined movement distance 24 (hereinafter, referred to as index feed). The control unit 100 of the laser processing apparatus 1 alternately repeats irradiation with the laser beam 21 with movement of the chuck table 10 along the second orientation flat 205 using the X-axis movement unit 31 and index feed a predetermined number of times. Thus, as illustrated in FIG. 9, the control unit 100 forms the plural separation layers 216-1, 216-2, 216-3, and 216-4, which are different in the output power of the laser beam 21, at intervals along the second orientation flat 205. In addition, the control unit 100 forms the plural separation layers 216-1, 216-2, 216-3, and 216-4, which are formed through the irradiation with the laser beam 21 with the respective output power values, at intervals along the first orientation flat 204.

As illustrated in FIG. 10, the control unit 100 of the laser processing apparatus 1 irradiates the separation layers 216-1, 216-2, 216-3, and 216-4 with the inspection light 41 from the light emitter 42 and images the separation layers 216-1, 216-2, 216-3, and 216-4 by the camera 43. Then, images 300 (illustrated in FIGS. 11A to 11D) acquired by the camera 43 are output to the control unit 100. In the images 300 in FIGS. 11A to 11D that are acquired by the camera 43, the intensity of the inspection light 41 reflected by a region 301 (illustrated by white in FIGS. 11A to 11D) in which cracks are formed is stronger than that of the inspection light 41 reflected by a region 302 (illustrated by parallel oblique lines in FIGS. 11A to 11D) in which cracks are not formed, and reflected by a region 303 (illustrated by black in FIGS. 11A to 11D) in which the modified part is formed.

Note that FIG. 11A is the image 300 (hereinafter, denoted by a reference sign 300-1) acquired by imaging the separation layer 216-1 formed through irradiation with the laser beam 21 with the first output power. FIG. 11B is the image 300 (hereinafter, denoted by a reference sign 300-2) acquired by imaging the separation layer 216-2 formed through irradiation with the laser beam 21 with the second output power. FIG. 11C is the image 300 (hereinafter, denoted by a reference sign 300-3) acquired by imaging the separation layer 216-3 formed through irradiation with the laser beam 21 with the third output power. FIG. 11D is the image 300 (hereinafter, denoted by a reference sign 300-4) acquired by imaging the separation layer 216-4 formed through irradiation with the laser beam 21 with the fourth output power.

In FIG. 11A and FIG. 11B, in the separation layers 216-1 and 216-2, an interval exists between the cracks adjacent to each other in the inclination direction 207. Further, in FIG. 11C and FIG. 11D, in the separation layers 216-3 and 216-4, the cracks adjacent to each other in the inclination direction 207 overlap.

Here, when the cracks 215 adjacent to each other in the inclination direction 207 do not overlap in the SiC ingot 200, it becomes difficult to separate the wafer 220 from the SiC ingot 200 with use of the separation layers 211 as the point of origin. On the other hand, when the cracks 215 adjacent to each other in the inclination direction 207 overlap in the SiC ingot 200, the wafer 220 can easily be separated from the SiC ingot 200 with use of the separation layers 211 as the point of origin. However, in the SiC ingot 200, when the output power of the laser beam 21 is excessively high, the cracks 215 are excessively produced along the c-plane 209 inclined with respect to the first surface 201 of the SiC ingot 200. Thus, when the separation surface 212 of the SiC ingot 200 and the separation surface 221 of the wafer 220 are ground to be planarized after the wafer 220 is separated from the SiC ingot 200, the amount of grinding becomes large. Therefore, the loss of the material increases.

In the first embodiment, the control unit 100 of the laser processing apparatus 1 extracts images in which all cracks overlap with the cracks adjacent in the inclination direction 207, from the images 300-1, 300-2, 300-3, and 300-4, and further extracts an image in which the output power of the laser beam 21 is the lowest. In the first embodiment, the control unit 100 extracts the image 300-3. The control unit 100 of the laser processing apparatus 1 sets the output power of the laser beam 21 of the extracted image 300-3 to the output power of the laser beam 21 that is used to form the separation layer 211 for separating the wafer 220 from the SiC ingot 200. In the first embodiment, the control unit 100 sets the third output power of the laser beam 21 used when the separation layer 216-3 of the image 300-3 is formed, to the output power of the laser beam 21 that is used to form the separation layer 211 for separating the wafer 220 from the SiC ingot 200.

In the first embodiment, the control unit 100 sets the output power of the laser beam 21 that is used to form the separation layer 211 for separating the wafer 220 from the SiC ingot 200, for example, through extracting images in which all cracks overlap with the cracks adjacent in the inclination direction 207 from the images 300-1, 300-2, 300-3, and 300-4. However, in the present invention, it may be determined whether or not the output power of the laser beam 21 used when the respective separation layers 216-1, 216-2, 216-3, and 216-4 are formed is the output power with which cracks are properly formed, depending on whether or not the brightness of the images 300-1, 300-2, 300-3, and 300-4 captured by the camera 43 is in a range of thresholds.

In this case, when data of the images 300-1, 300-2, 300-3, and 300-4 is input from the camera 43, the control unit 100 executes binarization processing on the respective images 300-1, 300-2, 300-3, and 300-4 with a threshold of a predetermined value. Note that it is desirable that the threshold be smaller than the intensity of the inspection light 41 reflected by the region 301 in which cracks are formed, and be larger than the intensity of the inspection light 41 reflected by the region 302 in which cracks are not formed, and reflected by the region 303 in which the modified part is formed.

When the binarization processing is executed, in the respective images 300-1, 300-2, 300-3, and 300-4, the regions 301 in which cracks are formed mainly become white, whereas the regions 302 in which cracks are not formed and the regions 303 in which the modified part is formed mainly become black. When the ratio of black and white is in a range of predetermined values (for example, the ratio of black is 30% to 40% and the ratio of white is 60% to 70%) in the images 300-1, 300-2, 300-3, and 300-4 subjected to the binarization processing, the control unit 100 determines that the output power corresponding to the image is output power with which cracks are properly formed. The control unit 100 sets the minimum output power value in the output power values with which cracks are properly formed, to the output power of the laser beam 21 that is used to form the separation layer 211 for separating the wafer 220 from the SiC ingot 200.

In the processing operation, after setting the output power of the laser beam 21, based on an image of the SiC ingot 200 captured by the camera 43, the control unit 100 of the laser processing apparatus 1 controls the movement unit 30 to adjust the relative position of the SiC ingot 200 and the beam condenser 23 of the laser beam irradiation unit 20. In the first embodiment, an outer edge part of the SiC ingot 200 that is close to the second orientation flat 205 is adjusted to face the beam condenser 23 along the Z-axis direction. At this time, the control unit 100 of the laser processing apparatus 1 sets the second orientation flat 205 so as to be parallel to the X-axis direction, sets the direction orthogonal to the inclination direction 207 so as to be parallel to the X-axis direction, and sets the inclination direction 207 so as to be parallel to the Y-axis direction.

In the processing operation, the control unit 100 of the laser processing apparatus 1 adjusts the position of the beam condenser 23 in the Z-axis direction by the focal point movement unit, to position the focal point 22 of the laser beam 21 to the depth 213 equivalent to the thickness 222 of the wafer 220 to be produced from the first surface 201 of the SiC ingot 200. As illustrated in FIG. 6, the control unit 100 of the laser processing apparatus 1 causes the beam condenser 23 to irradiate the SiC ingot 200 with the laser beam 21 with a wavelength having transmissibility with respect to SiC while causing the X-axis movement unit 31 to execute processing feed of the chuck table 10 at a predetermined processing feed rate along the X-axis direction, i.e., along the second orientation flat 205.

In the SiC ingot 200, as illustrated in FIG. 7, the separation layers 211 including the modified part 214 and the cracks 215, which extend from the modified part 214 along the c-plane 209, are formed due to the irradiation with the laser beam 21. In the modified part 214, SiC is separated into Si and C, and the pulsed laser beam 21 with which irradiation is executed next is absorbed by previously-formed C, separating SiC into Si and C in a chain-reaction manner.

When forming the separation layer 211 over the total length in the X-axis direction regarding the outer edge part of the SiC ingot 200 that is close to the second orientation flat 205, the control unit 100 of the laser processing apparatus 1 executes index feed of the chuck table 10 by the Y-axis movement unit 32 in such a direction that the beam condenser 23 of the laser beam irradiation unit 20 moves toward the center of the first surface 201 of the SiC ingot 200, by the predetermined movement distance 24 along the first orientation flat 204. The control unit 100 of the laser processing apparatus 1 alternately repeats irradiation with the laser beam 21 with movement of the chuck table 10 in the X-axis direction by the X-axis movement unit 31 and index feed until the separation layers 211 are formed on the whole region under the first surface 201. Then, the control unit 100 ends the processing operation.

Thus, in the SiC ingot 200, at every movement distance 24 of the index feed, the separation layer 211 that includes the modified part 214 arising from separation of SiC into Si and C and the cracks 215 and that has intensity lowered relative to the other part is formed at the depth 213 equivalent to the thickness 222 of the wafer 220 from the first surface 201. In the SiC ingot 200, at the depth 213 equivalent to the thickness 222 of the wafer 220 from the first surface 201, the separation layer 211 is formed at every movement distance of the index feed over the total length in the direction parallel to the first orientation flat 204.

As described above, in the laser processing apparatus 1 according to the first embodiment, the holding surface 11 of the chuck table 10 has the color 15 that absorbs the inspection light 41. Therefore, even when the SiC ingot 200 becomes thin and the separation layer 211 comes close to the holding surface 11, the intensity of the inspection light 41 reflected from the holding surface 11 can be suppressed because the holding surface 11 has the color 15 that absorbs the inspection light 41. As a result, the laser processing apparatus 1 can suppress an error in the inspection result of the separation layers 216-1, 216-2, 216-3, and 216-4 for inspection that are formed in the SiC ingot 200. In particular, the influence of reflected light from the holding surface 11 and the outer front surface of the base 13 is large in the vicinity of the outer circumference of the SiC ingot 200. However, in the laser processing apparatus 1 according to the first embodiment, an error in the inspection result of the separation layers 216-1, 216-2, 216-3, and 216-4 for inspection can effectively be suppressed because the holding surface 11 of the chuck table 10 has the color 15 that absorbs the inspection light 41.

Further, in the laser processing apparatus 1 according to the first embodiment, the outer front surface of the base 13 of the chuck table 10 has the color 15 that absorbs the inspection light 41. Therefore, the intensity of the inspection light 41 reflected from the outer front surface of the base 13 of the chuck table 10 can be suppressed.

Moreover, in the laser processing apparatus 1 according to the first embodiment, in the case in which the porosity of the porous plate 12 is at least 5% and at most 40% in volume ratio and the pressure of suction applied from the suction source 14 is −92.7 kPa (gauge pressure), the pressure in the suction path 137 becomes at least −65 kPa (gauge pressure) and at most −50 kPa (gauge pressure) when nothing is placed on the holding surface 11. In addition, the pressure in the suction path 137 becomes −84.2 kPa (gauge pressure) when the SiC ingot 200 whose diameter 210 is 4 inches is placed on the holding surface 11, the pressure in the suction path 137 becomes −87.9 kPa (gauge pressure) when the SiC ingot 200 whose diameter 210 is 6 inches is placed on the holding surface 11, and the pressure in the suction path 137 becomes −91.5 kPa (gauge pressure) when the SiC ingot 200 whose diameter 210 is 8 inches is placed on the holding surface 11.

As a result, the laser processing apparatus 1 can hold the SiC ingot 200 with various sizes under suction on the holding surface 11 without causing any trouble in laser processing.

### Second Embodiment

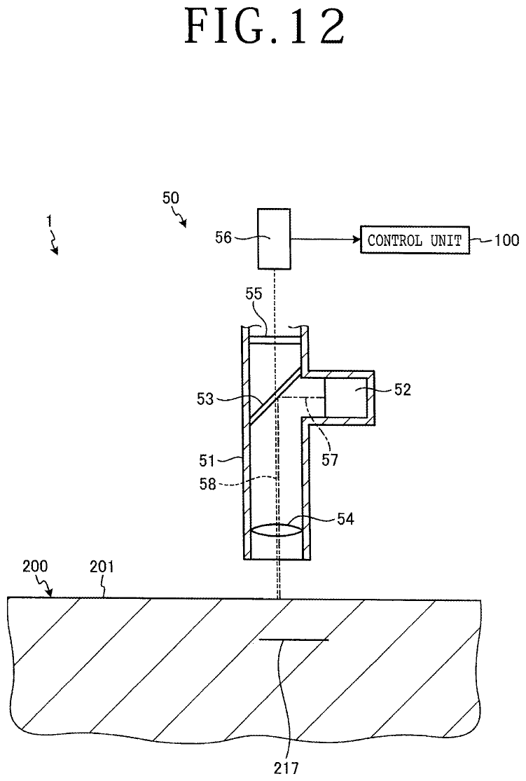

A laser processing apparatus according to a second embodiment of the present invention will be described based on a drawing. FIG. 12 is a side view schematically illustrating the state in which a detecting unit of the laser processing apparatus according to the second embodiment detects a Facet region in the SiC ingot. In FIG. 12, the same part as the first embodiment is given the same reference sign, and description thereof is omitted.

The laser processing apparatus 1 according to the second embodiment further includes a detecting unit 50 illustrated in FIG. 12.

A region 217 that is referred to as Facet and that is different in the crystal structure (hereinafter, referred to as a Facet region) exists inside the SiC ingot 200 in some cases. In the Facet region 217, the refractive index and the absorptance of energy are higher than those in the non-Facet region. Because of this, the SiC ingot 200 involves a problem that, when the Facet region 217 exists, the position and the quality of the separation layer 211 formed inside due to irradiation with the laser beam 21 become uneven and a step is produced in the separation layer 211 and the wafer 220 to be produced between the Facet region 217 and the non-Facet region.

The detecting unit 50 irradiates the SiC ingot 200 with excitation light 57 with a predetermined wavelength from the first surface 201 of the SiC ingot 200 and detects the luminance of fluorescence 58 specific to SiC. The detecting unit 50 detects, as the non-Facet region, a position in which the luminance of the fluorescence 58 is equal to or higher than a predetermined value, and detects, as the Facet region 217, a region in which the luminance of the fluorescence 58 is lower than the predetermined value.

As illustrated in FIG. 12, the detecting unit 50 includes a case 51 supported by the tip of the support column 4, a light source 52 that emits the excitation light 57 with such low output power (for example, 0.1 W) as not to execute laser processing on the SiC ingot 200 and with a predetermined wavelength (for example, 370 nm), and a dichroic mirror 53 that reflects the excitation light 57 with the predetermined wavelength emitted from the light source 52 and that allows transmission of light with a wavelength other than wavelengths in a first predetermined wavelength range (for example, 365 to 375 nm) including the above-described predetermined wavelength, through the dichroic mirror 53. The detecting unit 50 further includes a condensing lens 54 that collects the excitation light 57 reflected by the dichroic mirror 53 and that irradiates the SiC ingot 200 with the excitation light 57, a band-pass filter 55 that allows transmission of light in a second predetermined wavelength range (for example, 395 to 430 nm) through the band-pass filter 55, and a photodetector 56 that detects the luminance of the light transmitted through the band-pass filter 55.

In the detecting unit 50, the light source 52, the dichroic mirror 53, the condensing lens 54, and the band-pass filter 55 are disposed in the case 51. Further, although not illustrated in the diagram, the detecting unit 50 includes focal point position adjusting means that raises and lowers the case 51 to adjust the position of the focal point of the excitation light 57 in the Z-axis direction. This focal point position adjusting means includes, for example, a ball screw that is coupled to the case 51 and that extends in the Z-axis direction, a motor that rotates this ball screw, and so forth.

The control unit 100 of the laser processing apparatus 1 according to the second embodiment irradiates the first surface 201 of the SiC ingot 200 held on the holding surface 11 of the chuck table 10 with the excitation light 57 at every predetermined interval while controlling the movement unit 30 to relatively move the detecting unit 50 and the chuck table 10, and detects the fluorescence luminance of the first surface 201 of the SiC ingot 200 at every predetermined interval. At this time, the excitation light 57 emitted from the light source 52 is reflected by the dichroic mirror 53, guided to the condensing lens 54, and collected in the condensing lens 54. The excitation light 57 is then applied to the first surface 201 of the SiC ingot 200.

When the SiC ingot 200 is irradiated with the excitation light 57, the fluorescence (radiated light) 58 including a wavelength (for example, approximately 410 nm) different from the wavelength of the excitation light 57 is released from the SiC ingot 200. The fluorescence 58 is transmitted through the condensing lens 54 and the dichroic mirror 53. Then, only the fluorescence 58 in the second predetermined wavelength range is transmitted through the band-pass filter 55, and the luminance of the fluorescence 58 transmitted through the band-pass filter 55 is detected by the photodetector 56. In the laser processing apparatus 1, the detecting unit 50 detects the luminance of the fluorescence 58 specific to SiC from the whole of the first surface 201 of the SiC ingot 200 by the photodetector 56.

The photodetector 56 outputs, to the control unit 100, a signal indicating that the detected luminance of the fluorescence 58 is equal to or higher than the predetermined value or a signal indicating that the detected luminance of the fluorescence 58 is lower than the predetermined value. Based on detection results of the X-axis direction position detecting unit and the Y-axis direction position detecting unit, the control unit 100 detects, as the non-Facet region, a position in which the luminance of the fluorescence 58 is equal to or higher than the predetermined value, and detects, as the Facet region 217, a region in which the luminance of the fluorescence 58 is lower than the predetermined value.

The laser processing apparatus 1 according to the second embodiment properly controls the processing conditions under which the SiC ingot 200 is irradiated with the laser beam 21, on the basis of the positions of the detected Facet region and non-Facet region, and forms the separation layer 211 free from a step between the Facet region 217 and the non-Facet region to suppress a step in the wafer 220.

In the laser processing apparatus 1 according to the second embodiment, even when the SiC ingot 200 becomes thin and the separation layer 211 comes close to the holding surface 11, the influence of the fluorescence 58 from the holding surface 11 can be suppressed because the holding surface 11 has the color 15 that absorbs the inspection light 41. As a result, the laser processing apparatus 1 can suppress an error in the detection result of the Facet region 217 and the non-Facet region of the SiC ingot 200, i.e., the inspection result of the SiC ingot 200.

As above, when the holding surface 11 has the above-described color 15, the laser processing apparatus 1 can suppress the fluorescence measured, compared with the chuck table used conventionally. As a result, the laser processing apparatus 1 has an effect that, even when the SiC ingot 200 becomes thin, the influence of fluorescence of the chuck table 10 becomes small when it is sensed whether or not the Facet region 217 exists. Thus, the chuck table 10 with the above-described configuration may be used when the SiC ingot 200 is irradiated with the excitation light 57 and the fluorescence 58 of the SiC ingot 200 is sensed to detect the Facet region 217.

In particular, the SiC ingot 200 that has the Facet region 217 near the outer circumference of the SiC ingot is also used, and the laser processing apparatus 1 according to the second embodiment executes inspection to the very verge of the outer circumference of the SiC ingot 200 in detection of the Facet region 217. The influence of reflected light from the holding surface 11 and the outer front surface of the base 13 is large in the vicinity of the outer circumference of the SiC ingot 200. However, an error in the detection result of the Facet region 217 and the non-Facet region of the SiC ingot 200, i.e., the inspection result of the SiC ingot 200, can effectively be suppressed because the holding surface 11 of the chuck table 10 has the color 15 that absorbs the inspection light 41.

Note that the present invention is not limited to the above-described embodiments. That is, the present invention can be carried out with various modifications without departing from the gist of the present invention. For example, in the above-described embodiments, the base 13 of the chuck table 10 is composed of a metal such as stainless steel. However, in the present invention, the material of the base 13 is not limited to the metal such as raw stainless steel, and the base 13 may be composed of various kinds of glass such as soda glass (soda lime glass), borosilicate glass, or quartz glass that is a glass material or may be composed of a ceramic, as long as the material is a non-porous material with air impermeability.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A laser processing apparatus that forms a separation layer in an SiC ingot, the laser processing apparatus comprising:
a chuck table that holds the SiC ingot on a holding surface thereof;
a laser beam irradiation unit including a beam condenser that positions a focal point of a laser beam with a wavelength having transmissibility with respect to SiC, to a depth equivalent to a thickness of a wafer to be produced from an upper surface of the SiC ingot, and that irradiates the SiC ingot with the laser beam to form the separation layer arising from separation of SiC into Si and C and extension of cracks along a c-plane;
a movement unit that relatively moves the chuck table and the laser beam irradiation unit; and
a separation layer inspecting unit that executes irradiation with inspection light with such a wavelength as to have transmissibility with respect to the SiC ingot and be reflected by the separation layer and that inspects the separation layer from intensity of reflected light, wherein
the holding surface of the chuck table has a color that absorbs the inspection light.

2. The laser processing apparatus according to claim 1, wherein
the inspection light is visible light.

3. The laser processing apparatus according to claim 1, wherein
the holding surface of the chuck table includes a porous plate.

4. The laser processing apparatus according to claim 3, wherein
the porous plate is composed of porous glass.
